(19) United States
(12) Patent Application Publication
(10) Pub. No.: US 2024/0137274 A1
(43) Pub. Date: Apr. 25, 2024

(54) SYSTEMS AND METHODS FOR REST FRAMEWORK FOR MULTIPLE REST-BASED STORES

(71) Applicant: OPEN TEXT HOLDINGS, INC., Menlo Park, CA (US)

(72) Inventors: Pulla Rayudu Garaga, Bangalore (IN); Ananda Reddy Chichhili, Bangalore (IN); Siddaram Siddanna Bali, Bengaluru (IN)

(21) Appl. No.: 17/973,307

(22) Filed: Oct. 24, 2022

(51) Int. Cl. H04L 41/084; H04L 47/70; H04L 67/02; H04L 67/146

(52) U.S. Cl. CPC H04L 41/084; H04L 47/82; H04L 67/02; H04L 67/146

(57) ABSTRACT

Embodiments provide systems and methods for a generic representational state transfer (ReST) framework that can be used to communicate with heterogeneous ReST interfaces. On embodiment of a method comprises storing endpoint configurations for heterogeneous ReST interfaces as configurable files consumable by a ReST framework; receiving, by the ReST framework, a request to perform an operation and ReST resource details associated with the request to perform the operation; generating a ReST request, the ReST request including an endpoint URL for a target resource, a Hypertext Transfer Protocol (HTTP) method, and a header; and sending the ReST request to a ReST server. Generating the ReST request can comprise accessing the first endpoint configuration and extract first endpoint configuration data that is applicable to servicing the request to perform the operation, the first endpoint configuration data specifying the header; and mapping the operation to the HTTP method.

### TECHNICAL FIELD

This disclosure relates to the field of computer interfaces. More particularly, embodiments relate to a generic representational state transfer (ReST) framework that can be used to communicate with heterogeneous ReST interfaces. Even more particularly, embodiments relate to performing operations on resources provided via heterogeneous ReST interfaces.

### BACKGROUND

Cloud storage is available from many cloud computing providers. Each cloud computing provider, however, uses a different application programming interface (API) to allow other applications to programmatically communicate with the provider's cloud-based applications. As such, integrating cloud storage with other systems and applications can be a complex task. In one paradigm for integrating cloud storage with a content management system, the content management system includes a server plug-in for each cloud store API supported by the content management system. To integrate a new type of cloud store—say a cloud store provided by a new cloud storage provider—a developer develops a new plug-in using the content management system's API and the respective cloud storage provider's software development kit (SDK) API and installs the plug-in on the content management system. Installing the new plug-in requires restarting the content management system's content server.

The above approach tightly binds the plug-ins, SDKs, and the content management system's server, making the development of new plug-ins time consuming and complex. As each cloud store plug-in is directly consuming the public API of a respective cloud store, each plug-in is tightly coupled to a particular store and is not directly reusable for new stores. Further, changes to a cloud store's API can involve potentially complex rework of the plug-in and downtime of the server to deploy the updated plugin. Moreover, the use of multiple plug-ins can significantly increase the size of the content management service. More particularly, the requirement of having a different plug-in for each type of cloud store has an impact on binary size—that is the size of the executable or compiled code—and, in container-based distributions, container size.

### SUMMARY

A computer system can be configured to perform particular actions by virtue of software, firmware, hardware, or a combination thereof that causes the computer system to perform the actions. A computer program can be configured to perform particular operations or actions by virtue of including instructions that, when executed by data processing apparatus, cause the apparatus to perform the actions. One general aspect includes a representational state transfer (ReST) framework method. The ReST framework method can include providing a ReST framework for interfacing with heterogeneous ReST interfaces. The method also includes storing endpoint configurations for the heterogeneous ReST interfaces as configurable files consumable by the ReST framework; receiving, by the ReST framework, a request to perform an operation and ReST resource details associated with the request to perform the operation, where the ReST resource details include, for example, an endpoint URL for a target resource and an indication that a first endpoint configuration applies to servicing the request to perform the operation; generating a ReST request; and sending the ReST request to a ReST server. The ReST request includes the endpoint URL for the target resource, a first method (e.g., a Hypertext Transfer Protocol (HTTP) method), and a header. Generating the ReST request may include: accessing the first endpoint configuration and extracting first endpoint configuration data that is applicable to servicing the request to perform the operation, the first endpoint configuration data specifying the header; and mapping the operation to the first method. Other embodiments of this aspect include corresponding computer systems, apparatus, and computer programs recorded on a computer storage device.

Another general aspect includes a non-transitory computer readable medium having data stored therein representing software executable by a computer to provide a representational state transfer (ReST) framework. According to one embodiment, the software comprises instructions to allow the ReST framework to dynamically consume new endpoints and resources without stopping execution of the software or other applications that utilize the ReST framework. The software includes instructions for accessing configurable files storing endpoint configurations for heterogeneous ReST interfaces; receiving a request to perform an operation and ReST resource details associated with the request to perform the operation, the ReST resource details may include an endpoint URL for a target resource and an indication that a first endpoint configuration applies to servicing the request to perform the operation; generating a ReST request; and sending the ReST request to a ReST server. The ReST request includes the endpoint URL for the target resource, a first method (e.g., an HTTP method), and a header. Generating the ReST request may include: accessing the first endpoint configuration and extracting first endpoint configuration data that is applicable to servicing the request to perform the operation, the first endpoint configuration data specifying the header; and mapping the operation to the first method.

Embodiments provide an advantage in that the same framework—for example as implemented by a single plug-in—can support REST based stores that use different ReST APIs. Since a store's REST endpoints can be consumed dynamically in some embodiments, the framework can push or pull from/to the any ReST-based store using configuration files (e.g., XML config files) for the ReST stores. Moreover, ReST stores can be easily added.

Embodiments provide an advantage by providing a common ReST framework for heterogeneous ReST-based stores, including cloud-based stores.

Embodiments provide another advantage by providing a ReST framework that can connect to new ReST-based stores without redeploying or restarting the applications that use the ReST framework. Thus, new upgrades and customization can be achieved without service restart.

Embodiments of ReST frameworks according to the present disclosure can eliminate the need to download and load dependency libraries to add new ReST-based stores. This reduces class conflicts and reduces the memory footprint at application layer.

Embodiments can be implemented as a service to support a variety of ReST-based stores. In addition, the framework can be leverage for authentication, authorization and DB services.

As another advantage, new endpoint configuration files can be much smaller than a new plugin developed using an API SDK. As such, embodiments can allow new ReST-based stores to be added using significantly less data when compared to adding a new plugin.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a diagrammatic representation of one embodiment of an enterprise content management system.

FIG. 2A and FIG. 2B are diagrammatic representations of another embodiment of an enterprise content management system.

FIG. 3 is a diagrammatic representation of one embodiment of an endpoint configuration.

FIG. 4 is a diagrammatic representation of one embodiment of an authentication module.

FIG. 5 is a diagrammatic representation of another embodiment of an endpoint configuration.

FIG. 6 is a flowchart illustrating one embodiment of a method for a representational state transfer framework.

FIG. 7 is a diagrammatic representation of a distributed computer environment.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

Embodiments of the present disclosure provide a representational state transfer (ReST) framework that can be used with a variety of ReSTful interfaces (also referred to as ReST interfaces). According to one embodiment, the ReST framework provides a framework for integrating cloud storage across a wide range of providers and service-specific ReST interfaces.

Before proceeding, some additional context may be helpful. ReSTful interfaces abstract information accessible through the interface as resources. Resources can be files (word processing files, images, videos), streaming media, data provided by services, data provided by queries, or any of a broad variety of other types of data.

In a ReST architecture, the ReST server identifies each resource available through the ReST interface by a respective unique uniform resource identifier (URI). The ReST server typically identifies resources using a uniform resource locator (URL) that specifies a path or query string to the resource. Clients, which can include other servers, send ReST requests to the ReST server. A ReST request typically includes a URL for a resource and method to perform with respect to the resource. The URL is referred to as an endpoint and is a targetable URL for accessing the ReST resource. The ReST methods are typically hypertext transfer protocol (HTTP) methods, such as GET, POST, PUT, DELETE, PATCH. A ReST request typically also includes one or more of a header or request data (also referred to as the request body). Headers provide metadata about the message body, authentication tokens, cookies, format of the request or response, information about request status, or other information. The request body includes content or the resource representation. For example, the request data may include data to be stored by the ReST server using the PUT, PULL, or PATCH methods. The endpoint URLs, methods supported, headers, and format of the resource representations for requests and responses can vary depending on the API.

In some embodiments, the ReST framework maps operations of an application to ReST methods. In an even more particular embodiment, the operations that can be performed on ReST resources can be abstracted to create, update, read, and delete (CRUD) operations on the resources, and the ReST framework maps the CRUD operations to corresponding HTTP methods—for example, POST, GET, PUT and DELETE.

The ReST framework pushes/pulls data from ReST interfaces using endpoint configurations, resource details and the mapped methods. The endpoint configuration and resource details are dynamically updateable—that is, updateable without stopping execution of the ReST framework or an application that uses the ReST framework to communicate with ReST servers—in some embodiments.

Resource details include a variety of metadata about a resource, such as, but not limited to, indications of related resources, an indication of an endpoint configuration, the endpoint URL for performing various methods with respect to the resource, credentials, or other information. According to one embodiment, resource details can be used to determine the endpoint URL to include in ReST requests with respect to the resource.

The indication of an endpoint configuration associates a resource with an endpoint configuration. For example, a system integrating a ReST resource can store resource metadata including an attribute that indicates an endpoint configuration, where the associated endpoint configuration includes a set of endpoint configuration data to use when generating ReST requests with respect to the resource.

In general, an endpoint configuration specifies one or more of an endpoint, a header, a ReST method or an operation related parameter for use when generating ReST requests on resources or endpoints to which the endpoint configuration applies. An endpoint configuration, according to one embodiment, comprises endpoint configuration data that maps operations of an application—for example, operations of a first server—to one or more of an endpoint, an HTTP method, a header or a request parameter. In an even more particular embodiment, an endpoint configuration maps the operations of an application to headers, parameters, or HTTP methods based on tags in the endpoint configuration, the structure of the endpoint configuration data, or using other features of the endpoint configuration data. As such, the endpoint configuration has a format that can be parsed by the ReST framework to extract endpoint configuration data for various operations. In some embodiments, the endpoint configuration data varies for different operation types or resource types. Moreover, the available operations may vary by resource type, which can be indicated in the endpoint configuration data.

In some embodiments, the ReST framework can include an endpoint configuration for each ReST API supported by the framework with, for example, each endpoint configuration corresponding to a respective ReST API. Endpoint configurations, in some embodiments, are stored as files, such as, but not limited to, XML, JSON, YAML, or other files. The endpoint configuration files can be added to a known location (for example, in a database or file system) for consumption by the ReST framework.

Integrating a new resource according to a new endpoint configuration includes developing a set of endpoint configuration data from, for example, the ReST API documentation of a provider. As discussed, an endpoint configuration can specify endpoints, headers or other information for supported operations on endpoints associated with the endpoint configuration—or put another way, the endpoint configuration specifies endpoints, headers, or other information for supported operations on the resources associated with the endpoint configuration. The endpoint configuration data may, for example, include headers or other information mapped to operations as used by the system with which the new resource is to be integrated. The available operations can vary based on resource types and the endpoint configuration can vary based on resource type or operation type. A user with sufficient privileges stores the new endpoint configuration data as an endpoint configuration in a location accessible by the ReST framework. In one embodiment, the endpoint configuration is stored as a file having a filename that indicates the endpoint configuration.

Further, a ReST resource is created at the ReST server. As will be appreciated, when a resource is created by a ReST server based on a request from a ReST client, the ReST server returns information about the resource to the ReST client including the URI (e.g., endpoint URL for the resource). The ReST-server may return multiple URIs for a resource when a resource is created on the platform. For example, a ReST server may return different URLs for different methods (e.g., a first URL for performing GET requests, a second URL for performing POST requests).

The resource details (e.g., resource metadata) for the new resource are stored in the system in which the resource is being integrated. According to one embodiment, the resource details include, for example, an indication that the resource is associated with the new endpoint configuration and the endpoint URI (e.g., URL) for the resource. The resource details may include URLs for different methods. Other examples of resource details include, but are not limited to, credentials for accessing the resource and an authentication method. According to one embodiment, the new endpoint configuration and resource details can be added without stopping the ReST framework or, in some embodiments, the application into which the ReST resource is being integrated.

To integrate a new resource associated with existing endpoint configuration, the system into which the new resource is being integrated or a user with sufficient privileges creates the new resource at the ReST server and stores the resource details (e.g., resource metadata) in the system in which the resource is to be integrated.

According to one embodiment, when the system in which the resource is integrated is processing a request to perform an operation with respect to the new resource, the system provides the request and resource details to the ReST framework. The system may also provide data for the request body to the ReST framework. The ReST framework accesses the indicated endpoint configuration, retrieves the endpoint configuration data for the operation to be performed, generates the appropriate ReST request using the endpoint URL for the resource, the method that maps to the requested operation, the headers or other configuration data and the body data provided for the requested operation. The ReST framework sends the ReST request to the ReST-based platform.

In some embodiments, the ReST framework supports custom authentication modules that can be dynamically loaded. In an even more particular embodiment, an endpoint configuration includes authentication header information that references an authentication module. The ReST framework dynamically loads the authentication module to generate an access token or other authentication data to include in ReST requests with respect to resources associated with the endpoint configuration.

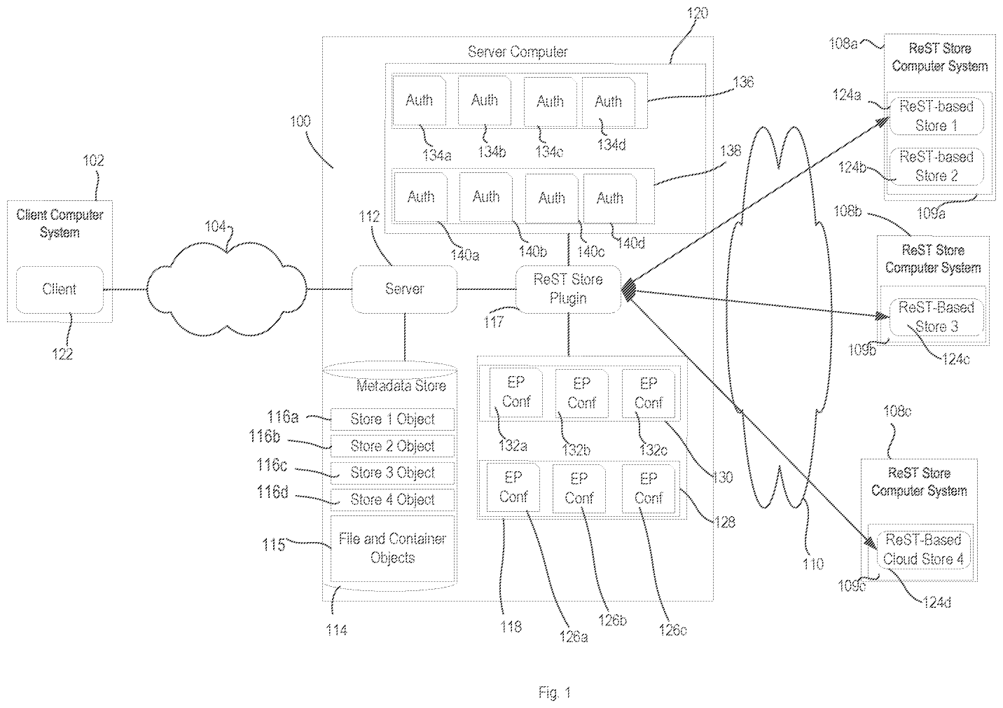

FIG. 1 is a diagrammatic representation of one embodiment of an enterprise content management compute system that includes a ReST framework. In the environment of FIG. 1, a server computer system 100 is bi-directionally coupled to a client computer system 102 by a network 104. Server computer system 100 is also bi-directionally coupled to ReST store computer systems 108a, 108b, 108c by a network 110. Each of network 104 and network 110 comprises a local area network (LAN), a wide area network (WAN) such as the Internet, a cellular network, a Wi-Fi network or other type of network or combination of networks. While illustrated separately, network 104 and network 110 may be or include the same network.

In the embodiment of FIG. 1, each ReST store computer system 108a, 108b, 108c includes a ReST server (ReST server 109a, ReST server 109b, ReST server 109c) that provides ReST-based stores as resources via a respective ReST API (ReST-based store 124a, ReST-based store 124b, ReST-based store 124c, and ReST-based store 124d are illustrated). In some embodiments, one or more of ReST-based store 124a, ReST-based store 124b, ReST-based store 124c, or ReST-based store 124d is a cloud-based store. Server computer system 100 integrates the ReST-based stores as storage locations for storing content.

Server computer system 100 comprises a server 112 that provides content management services to client applications, such as client application 122 running on client computer system 102. Server 112 manages content in a repository. According to one embodiment, a repository comprises a metadata database 114 (e.g., a relational database or other type of database) and a place to store files (e.g., one or more local or remote storage areas). The content files (e.g., word processing files, spreadsheet files, image files, or other files) in the repository can reside in various storage elements depending on the configuration of the repository. Example storage elements include, but are not limited to, local file systems local to server 112, networked file systems, content databases, and ReST-based stores, including cloud-based stores.

In the embodiment of FIG. 1, server 112 stores content files to ReST-based store 124a, ReST-based store 124b, ReST-based store 124c, and ReST-based store 124d. According to one embodiment, each ReST-based store is a resource accessible via a ReST API and to which other resources can be added. Even more particularly, each ReST-based store is a resource to which containers (e.g., buckets, folders, or other containers) and files can be added as resources. In an even more particular embodiment, each ReST-based store stores containers and files in a hierarchical manner.

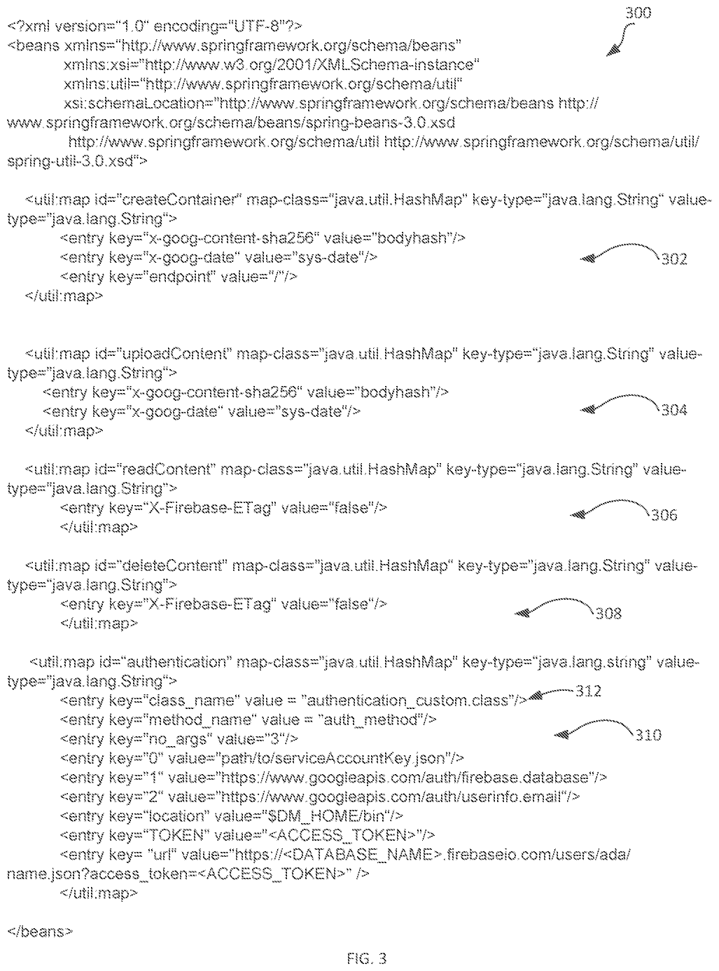

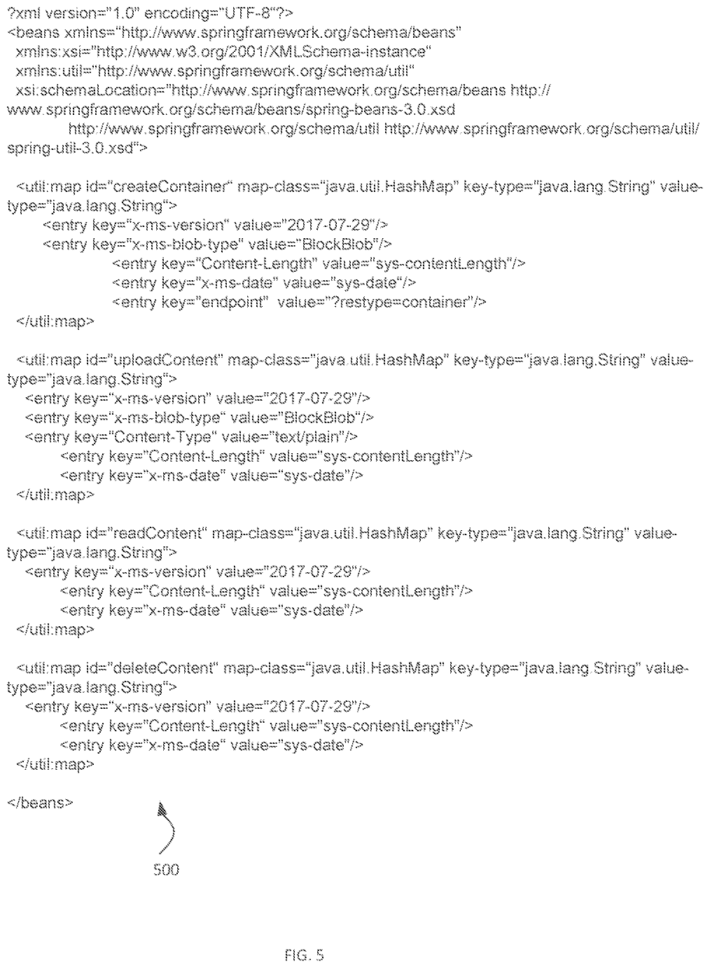

Server 112 supports a number of CRUD operations with respect to storing and organization content in a repository, such as the creation of containers, modification of containers, deletion of containers, reading of containers, creation of content (e.g., files), modification of content, deletion of content, and reading of content from the repository. ReST store plugin 117 maps CRUD operations to respective HTTP methods (e.g., POST, PUT, GET, DELETE) to create, modify, read, and delete containers and content at the ReST-based stores. It can be noted that, in some embodiments, server 112 or ReST store plugin 117 only supports a subset of CRUD operations on containers or content. For example, in the embodiment of FIG. 3 and FIG. 5, ReST store plugin 117 supports the creation of containers and the creation, deletion, and reading of content.

Server 112 stores information in the repository as objects. Server 112, for example, stores rest_store objects representing respective ReST-based stores (e.g., rest_store object 116a including details of ReST-based store 124a, rest_store object 116b including details of ReST-based store 124b, rest_store object 116c including details of ReST-based store 124c, and rest_store object 116d including details of ReST-based store 124d are illustrated) content objects representing respective content files, and container objects representing respective containers (content objects and container objects are represented generally at content and container objects 115). The content file associated with a content object is stored in a content storage area of the repository, such as ReST-based store 124a, ReST-based store 124b, ReST-based store 124c, or ReST-based store 124d. The container objects represent containers created in the content storage areas. Thus, the content objects and container objects in the repository can represent a hierarchy of containers and content stored in a ReST-based store. As will be appreciated, the containers and files may be stored as objects by the ReST-based stores.

An object has associated metadata. In one embodiment, server 112 stores the metadata of content objects, container objects and rest_store objects in metadata database 114. In an even more particular embodiment, server 112 stores the metadata for each content object, container object and rest_store object of a repository as a respective record in a relational database. A content object can include metadata such as a filename, storage location (e.g., store id of the ReST-based store to which the content file was uploaded), URI or URL of the file at a ReST-based store, creation date, container or other metadata). As another example, a container object can include metadata such as a container name, storage location (e.g., store id of the ReST-based store in which the container was created), URI or URL of the container at a ReST-based store, creation date, linked objects and other metadata). According to one embodiment, the details of a ReST-based store included in a rest_store object comprise a store id for the associated ReST-based store, an indication of a data store type, credentials for accessing the ReST-based store, the URL of the ReST-based store. When a content object, container object or rest_store object represents a ReST resource, the associated metadata of a content object, container object, or rest_store object can include the resource details of the respective ReST resource.

As will be appreciated, ReST-based stores are provided by a number of cloud computing providers. Examples of ReST-based stores include, but are not limited to, Google Cloud Platform (GCP) storage, Microsoft Azure Blob Storage, Amazon S3 storage and others (Google and GCP are trademarks of Google LLC of Mountain View, California; Microsoft and Azure are trademarks of Microsoft Corporation of Redmond Washington, Amazon S3 is a trademark of Amazon Technologies, Inc. of Seattle, Washington) (all trademarks and tradenames used herein are the property of their respective owners). The data store type can indicate, for example, that the data is a GCP data store, an Amazon S3 data store, an Azure data store or other type of data store. In any event, the data store type can be used as the indication of the endpoint configuration to use for ReST requests to the ReST-based store represented by the rest_store object. In other embodiments, another indicator of endpoint configuration can be used, such as an endpoint configuration identifier.

Embodiments of the present disclosure provide a common framework for ReST-based stores, including cloud-based stores, that use different ReST APIs. In the illustrated embodiment, server computer system 100 includes a ReST framework (implemented as a ReST store plugin 117), an endpoint configuration store 118 that stores endpoint configurations for ReST-based stores utilized by server 112, and an authentication module store 120 that stores authentication modules for the ReST-based stores. Server computer system 100 includes information to authenticate with and perform operations with respect to each ReST-based store 124a, 124b, 124c, 124d.

The ReST-based stores are associated with endpoint configurations. According to one embodiment, the association between a ReST-based store and an endpoint configuration is embodied in the rest object for the ReST-based store or the metadata of the endpoint configuration. For example, in one embodiment, each endpoint configuration is stored in association with an indicator of the data store type to which the endpoint configuration applies and the respective rest_store objects for the ReST-based stores to which the endpoint configuration applies indicate the same data store type, thereby linking the ReST-based store represented by the rest_store object with the endpoint configuration. In an even more particular embodiment, the data store type (or other indicator of endpoint configuration) is included in the file name of the endpoint configuration file and in the rest_store objects representing ReST-based stores to which the endpoint configuration applies. For example, the endpoint configuration for GCP ReST-based stores may be stored as a file named gcp-template.xml and the rest_store objects for the ReST-based stores to which the endpoint configuration applies may include a data store type of GCP.

In the embodiment of FIG. 1, endpoint configuration store 118 includes an endpoint configuration 126a for a first type of ReST-based store (for example, a ReST-based store type corresponding to ReST-based store 124a and ReST-based store 124b), endpoint configuration 126b for a second type of ReST-based store (a ReST-based store type corresponding to ReST-based store 124c), and endpoint configuration 126c for a third type of ReST-based store (a ReST-based store type corresponding to ReST-based store 124d).

According to one embodiment, the endpoint configuration store includes multiple levels, including a first endpoint configuration store 128, such as a local filesystem or other store, and a cache 130 from which endpoint configurations can be more quickly accessed. If the endpoint configuration for a particular store is not in cache 130 when needed, ReST store plugin 117 reads the endpoint configuration from endpoint configuration store 118 into an endpoint configuration cache 130 (e.g., as cached endpoint configuration 132a for ReST-based store 124a and ReST-based store 124b, cached endpoint configuration 132b for ReST-based store 124c, and cached endpoint configuration 132c for ReST-based store 124d are illustrated). In some embodiments, an endpoint configuration store, such as first endpoint configuration store 128, is implemented as a portion of metadata database 114.

The endpoint configuration for a ReST-based store type includes one or more of an endpoint, a header, or an operation related parameter for use when generating ReST requests on resources or endpoints to which the endpoint configuration applies. More particularly, the endpoint configuration for a ReST-based store type can include the specific ReST endpoints, headers or other information to perform operations related to resources of the associated ReST-based stores to which the endpoint configuration applies. For example, one embodiment of an endpoint configuration includes the specific ReST endpoints and headers for the creation, modification, deletion, or reading of containers (e.g., buckets or other containers) or content (e.g., files) at or from ReST-based stores of the data store type. According to one embodiment, the endpoint configuration for each ReST-based store or type of ReST-based store is stored in a respective configurable file, such as an XML file, a JSON file, a YAML file or according to another suitable language.

In some embodiments, ReST store plugin 117 is configured to use tags, structure, the order in which information appears in the endpoint configuration or other features in the endpoint configuration for a ReST-based store to extract the endpoints, headers or other information that map to content management operations. As illustrated in FIG. 3 and FIG. 5 discussed below, the endpoint configuration data may vary based on the operation type or resource type.

The endpoint configuration for a ReST-based store is used as a template for the endpoints, headers or other parameters for ReST requests to ReST-based stores associated with that endpoint configuration. For example, endpoint configuration 126a, according to one embodiment, includes ReST endpoints, headers or other parameters for ReST requests for one or more of the creation of containers, modification of containers, deletion of containers, reading of containers, uploading content (e.g., files), modification of content, deletion of content, or reading of content at or from ReST-based stores 124a, 124b.

Server computer system 100 includes an authentication module store 120 that includes an authentication module for each of the ReST-based store types. In some cases, server computer system 100 stores multiple authentication modules for the same type of ReST-based store when, for example, a ReST-based store supports multiple forms of authorization, such as signature version 4 and OAuth (Open Authorization). Authentication module store 120 of FIG. 1, for example, includes authentication module 134a for a first type of ReST-based store (a ReST-based store type corresponding to ReST-based store 124a and ReST-based store 124b), authentication module 134b for a second type of ReST-based store (a ReST-based store type corresponding to ReST-based store 124c), and an authentication module 134c and authentication module 134d for a third type of ReST-based store (a ReST-based store type corresponding to ReST-based store 124d). Thus, in the embodiment of FIG. 1, ReST-based store type specific authentication modules are provided as separate modules from the endpoint configurations, though, in some embodiments, the endpoint configuration associated with a ReST-based store references the authentication module.

Similar to endpoint configuration store 118, the authentication module store 120 of some embodiments includes multiple levels, including a first module authorization store 136, such as a local filesystem or other store, and an authentication module cache 138 from which authentication modules can be retrieved more quickly. If the authentication module for a particular store is not in cache 138, ReST store plugin 117 reads the authentication module from authentication module store 136 into cache 138 (e.g., as cached authentication module 140a for ReST-based store 124a, cached authentication module 140b for ReST-based store 124b, cached authentication module 140c for ReST-based store 124c and authentication modules 140d, 140e for ReST-based store 124d are illustrated). In some embodiments, an authentication module store, such as first authentication module store 136, is implemented as a portion of metadata database 114.

An authentication module for a ReST-based store includes information to allow ReST store plugin 117 to authenticate with a ReST-based store. According to one embodiment, each authentication module is stored as a file that contains code to allow ReST store plugin 117 to receive authorization to access a data store. In some cases, when a given type of ReST-based store supports multiple forms of authorization, such as signature version 4 and OAuth (Open Authorization), server computer system 100 includes separate authentication modules for each form of authorization supported by a ReST-based store. As illustrated in FIG. 1, for example, server computer system 100 includes authentication module 134c and authentication module 134d for ReST-based store 124d. According to one embodiment, the authentication modules are referenced in the endpoint configurations. In addition, or in the alternative, an authorization type may be included in a rest object for a ReST-based store to indicate the authentication module to use.

Integrating a ReST-based store of a previously unsupported type with server 112 can include a configuration phase. During this phase, a set of endpoint configuration data for the store type is developed from, for example, the ReST API documentation of a service provider. An endpoint configuration can specify endpoints, headers or other information for supported operations on endpoints associated with the endpoint configuration—or put another way, the endpoint configuration specifies endpoints, headers, or other information for supported operations on the resources associated with the endpoint configuration. The endpoint configuration data may, for example, include headers or other information mapped to CRUD operations of server 112. As mentioned, the available operations can vary based on resource types and the endpoint configuration data can vary based on operation type or resource type. According to one embodiment, a user with sufficient privileges stores the endpoint configuration data as an endpoint configuration in a location accessible by the ReST framework. For example, the administrator saves a new endpoint configuration file for the store type in endpoint configuration store 128 using a filename that indicates the store type.

Further, a user with sufficient privileges creates a new ReST-based store on a ReST-based platform. The ReST-based store details (e.g., ReST-based store metadata) are stored in a respective rest_store object. The ReST-based store details include, for example, a store id for the associated ReST-based store, an indication of a data store type, credentials for accessing the ReST-based store, the URL of the ReST-based store, or other resource details for the new ReST-based store. In this case, the indication of the data store type indicates that the new ReST-based store is associated with the new endpoint configuration. As will be appreciated, a ReST-based platform may return multiple URLs for a resource when a resource is created on the platform. For example, a ReST-based platform may return different URLs for different methods (e.g., a first URL for performing GET requests, a second URL for performing POST requests). In some embodiments then, the rest_store object may include URLs for different methods. In any case, it can be noted that the new endpoint configuration and rest_store object can be added without stopping ReST store plugin 117 or server 112.

In operation, server 112 receives a request from client application 122 to perform a content management operation with respect to a container object or content object in the repository. If the container or file is a new container or file, server 112 creates a new container object or content object (for example, generating a unique id for the container or file and storing available metadata for the container or file in metadata database 114). Server 112 further determines a ReST-based store for servicing the request. In some embodiments, the client specifies the ReST-based store in the request. In other embodiments, server 112 determines the ReST-based store to use based on rules. Server 112 stores an indication of the ReST-based store in the metadata of the container object or content object representing the container or file.

If the request is to perform a content management operation on a container or file that is already a resource in a ReST-based store, server 112 determines the ReST-based store from the storage location specified in the metadata of the respective content object or container object. Server 112 retrieves the endpoint URL for the resource to which the corresponding ReST request will be directed from the content object or container object.

Further, server 112 accesses the rest_store object for the selected ReST-based store or ReST-based store indicated in the content object or container object and retrieves the resource details including, for example, the endpoint URL of the ReST-based store and the data store type. For example, if the request is to perform a content management operation with respect to a container or content file in ReST-based store 124a, server 112 retrieves the details of ReST-based store 124a from rest_store object 116a. Server 112 passes the request and resource details of the ReST-based store and resource details of the target container or target file, if available, to ReST store plugin 117. For example, server 112 passes the data store type and endpoint URLs of the ReST-based store, the target container or target file, if available, to ReST store plugin 117. Further, in some cases, server 112 passes file data from the client to upload to the ReST-based store.

ReST store plugin 117 determines the endpoint configuration to load based on the data store type of data store indicated by server 112 (e.g., from the rest_store object for that data store) and loads the endpoint configuration for that type of ReST-based store from cache 130 or, if the endpoint information is not in cache 130, ReST store plugin 117 reads the endpoint information from first endpoint configuration store 128 and caches the endpoint information in cache 130. If an authorization type is specified for the ReST-based store, for example as part of the ReST-based store details or in the endpoint configuration, ReST store plugin 117 loads and executes the authentication module for the authorization type and ReST-based store type.

The ReST framework thus uses the rest_store object for a ReST-based store to extract the store details, such as data store type, endpoint URL for the ReST-based store, credentials and also extracts activity/operation related parameters, endpoints or headers from the respective endpoint configuration. By using the endpoint configuration and one or more of the information from the store object (e.g., rest_store object 116a), the content object or container object, or data provided by the client, the framework prepares a ReST request to the URL. Further, in some embodiments, the ReST framework executes an authentication module to receive authorization information, such as access tokens, to be included in the ReST request.

As will be appreciated, when a resource (e.g., container, file) is created in a ReST-based store, the ReST-server implementing the ReST interface returns a URI (e.g., an endpoint URL) for the resource—in some cases, different URIs for different methods. The endpoint URL returned by the ReST server is stored in the respective container object or content object representing the newly created resource. Thus, when an operation is requested on a container or file that has been created as a resource at the ReST-based store, the server can pass the URL for the resource to the ReST store plugin. If the resource details include different URLs for different methods, ReST store plugin 117 selects the URL for the method that maps to the requested content management operation. Otherwise, the ReST framework can use the endpoint URL of the ReST-based store.

In some embodiments, the ReST endpoints are defined in XML, JSON or other suitable language, in configurable files. Endpoints can be easily updated by updating the file for a ReST-based store type. Moreover, endpoints can be added for new types of ReST stores by adding new files (e.g., XML files) to the endpoint configuration store. According to one embodiment, the configuration files defining ReST endpoints are named according to the types of ReST-based stores to which they apply. As such, if ReST store plugin 117 receives an indication of a ReST-based store type, ReST store plugin 117 can easily identify the file defining the endpoints for the ReST-based store type. Similarly, authentication modules may be stored as files that are easily identifiable based on the authorization type, the ReST-based store type, or other information.

In the approach of FIG. 1, a common ReST-based framework handles ReST requests to ReST-based stores using different ReST APIs. API specific endpoints, headers, or other information for creation/modification/deletion/reading of containers (e.g., buckets) and objects representing content (e.g., files) are present in configurable files, such as XML or JSON. Authentication modules can be provided as separate modules that are loaded dynamically by the ReST store plugin 117 based on the ReST-based store type. Communication between ReST store plugin 117 and cloud stores occurs via ReST calls. The framework is extensible to new ReST stores by adding additional configuration files and authentication modules as needed.

New ReST-based stores can be integrated with no service downtime (e.g., without stopping server 112). A new ReST-based store of an existing type can be added by adding a store-specific rest_store object for the ReST-based store to metadata database 114. A ReST-based store of a new store type can be added by adding a new in XML (or other language) endpoint configuration to endpoint configuration store 118, adding authentication modules to as needed to authentication module store 120, and adding a store-specific rest_store object for the ReST-based store to metadata database 114. Since an update to ReST store plugin 117 is not required, server 112 does not have to be stopped.

Further, adding new ReST-based stores requires a relatively small amount of new data for each store and data store type and does not increase the size of the binaries/service to the same extent as adding new plugins.

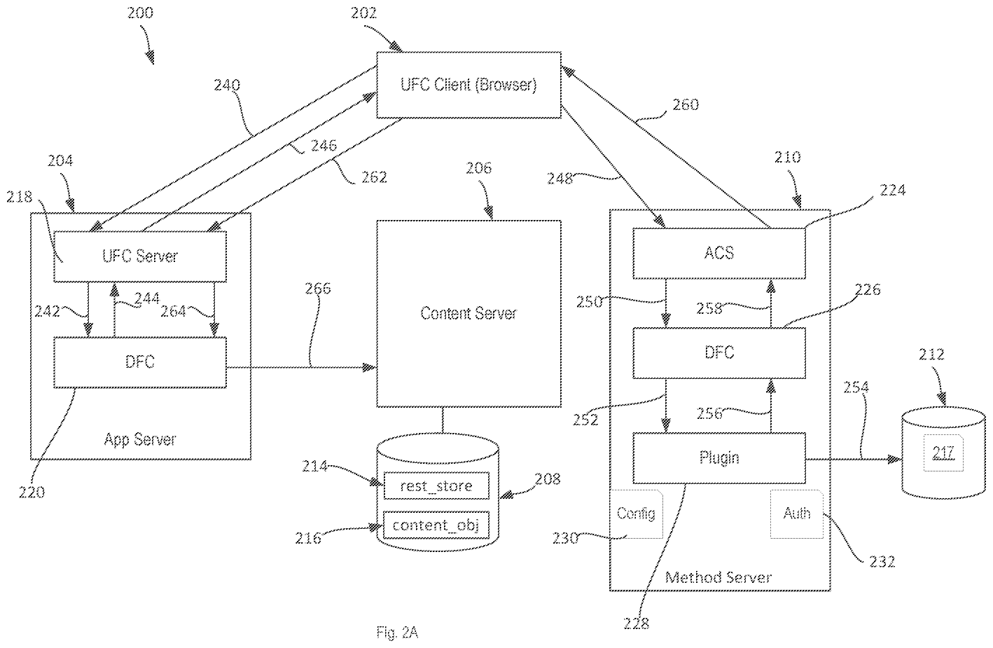

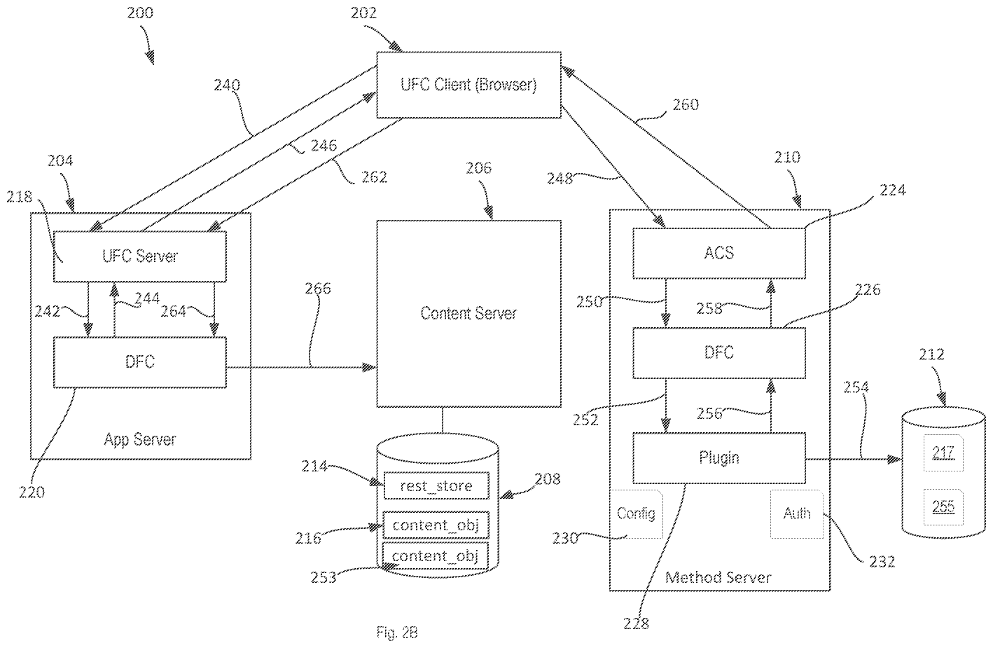

Embodiments of the present disclosure can be implemented in a variety of system architectures. FIG. 2A and FIG. 2B, for example, illustrates an enterprise content management system 200 according to a Documentum framework (Documentum is a trademark of Open Text Corporation of Waterloo, Ontario Canada).

Enterprise content management system 200 includes a unified client facilities (UCF) client (UCF client 202), an application server 204, a content server 206, a metadata database 208, a method server 210, and a ReST-based store 212. Application server 204 comprises UCF server 218 and Documentum Foundation Classes (DFC) 220. Method server 210 comprises Accelerated Content Services (ACS) 224, DFC 226, and ReST store plugin 228.

Content server 206 comprises software that manages, protects, and imposes an object-oriented structure on the information in repositories. Content server 206 provides tools for managing the lifecycles of that information and automating processes for manipulating it. Content server 206 provides client access to the repository. Content server 206 receives queries from clients in the form of DFC methods or Documentum Query Language (DQL) statements and makes calls to the metadata database 208 or file storage locations.

In the embodiment illustrated, metadata database 208 includes object metadata for a rest_store object 214 representing ReST-based store 212. The rest_store object 214 includes information such as credentials for accessing ReST-based store 212, the URL of the ReST-based store 212, and other information. A file is stored in the repository as content object 216, which comprises metadata stored in metadata database 208 and an associated content file 217 stored in ReST-based store 212. The metadata of content object 216 identifies the ReST-based store in which the associated file 217 is stored. In some embodiments, content object 216 also includes the URL endpoint for performing operations on file 217. It will be appreciated that the enterprise content management system may incorporate any number of ReST-based stores and store any number of content objects.

UCF client 202 is a lightweight client-based service that transfers content between the client, application server 204, and content server 206. The UCF APIs provide a remote client presence that can access the client file system, registry, and network resources (URLs). On the application server 204, UCF server 218 provides the base client access to content library services such as import, export, check in, and checkout. Web-based applications running in browsers use a content transfer browser extension to establish the connection with UCF server 218 on the application server host.

DFC (e.g., DFC 220, DFC 226) is a framework for accessing the capabilities of content server 206. For example, DFC provides access to content server functionality from within an enterprise's applications. DFC runs on the machine that runs the content server, a middle-tier system—for example, on an application server to support or execute server methods—and/or elsewhere in a system.

ACS 224 is a light-weight server. ACS 224 reads and writes content for web-based client applications using HTTP and HTTPS protocols. ACS 224 does not modify object metadata but writes content to storage areas.

ReST store plugin 228 communicates with ReST-based store 212. ReST store plugin 228 uses information from rest_store object 214, content object 216 and an endpoint configuration file 230 to communicate ReST requests to ReST-based store 212 to perform operations with respect to file 217. According to one embodiment, endpoint configuration file 230 is an XML or other language file that defines endpoints, headers or other information for performing content management operations with respect to ReST-based store 212. Endpoint configuration file 230 may be specific to ReST-based store 212 or a type of ReST-based store. Endpoint configuration file 230, according to one embodiment, indicates an authentication module 232 to use to generate information to include in an authentication header of ReST-based requests to ReST-based store 212. According to one embodiment, authentication module 232 is specific to a type of ReST-based store and an authorization type. ReST store plugin 228 can support any number of ReST-based stores and authentication modules.

According to one embodiment, when a user pushes new content to be stored, UCF client 202 requests the URL for ACS 224 from UFC server 218 (data flow 240). UCF server 218 requests the ACS write URL from DFC 220, with object metadata for the object to be stored (data flow 242). DFC 220 fetches the object details (e.g., object metadata) for the object to be stored from content server 206. In some embodiments, content server 206 creates a new content object 253 for the new content (FIG. 2B). The new content object 253 can include, for example, an indication of the data store to which the associated content file is to be stored and other metadata of the file to be uploaded. DFC 220 sends the object details to UCF server 218 (data flow 244). UCF server 218 frames the ACS write URL to contain the object details and sends the ACS write URL with the object metadata for the object to be stored to the UCF client (data flow 246). The UCF client 202 uses the ACS write URL to send a write request to ACS 224 and starts pushing the content to ACS 224 in chunks (data flow 248).

ACS 224 receives the write request and passes it on to DFC 226 (data flow 250). DFC 226 retrieves the ReST-based store details for ReST-based store 212 from content server 206. For example, DFC 226 fetches the ReST-based store details (e.g., metadata stored in rest_store object 214) from content server 206 based on the data store indicated in the content object details. DFC passes the request and details of the ReST-based store 212 and content object 253 to ReST store plugin 228 (data flow 252).

ReST store plugin 228 determines if the endpoint configuration file 230 for the data store type is in cache and, if authorization is required, authentication module 232 is in cache. If endpoint configuration file 230 or authentication module 232 is not in cache, ReST store plugin 228 reads them into cache. ReST store plugin 228 loads an endpoint configuration from endpoint configuration file 230 and, if authorization is specified, executes the authentication module 232. ReST store plugin uses the endpoints defined in endpoint configuration file 230 and data store specific details passed by DFC 226 to generate ReST calls to ReST-based store 212 to write the content to ReST-based store 212 (data flow 254).

ReST-based store returns a result to ReST store plugin 228. The result may indicate for example that file 255 was successfully created in ReST-based store 212. ReST store plugin 228 returns a write result to DFC 226 (data flow 256). This result includes information, such as the content handle on ReST-based store 212 (e.g., the endpoint URL of the file), the content size and content hash. DFC 226 then returns the result to ACS 224 by wrapping the result in a format consumable by ACS 224 (data flow 258). ACS 224 returns the result to UCF client 202 (data flow 260).

UCF client 202 sends the result to UCF server 218 (data flow 262) and UCF server 218 passes the result to DFC 220 (data flow 264). DFC 220 sends the result to content server 206 (data flow 266), and content server 206 stores metadata to metadata database 208 (e.g., in content object 253). Such metadata may include, for example, the endpoint URL for file 255.

FIG. 3 illustrates one embodiment of an endpoint configuration 300 for a Google GCP data store. In the embodiment of FIG. 3, it is assumed that the content management system supports the following operations with respect to ReST-based stores: createContainer, uploadContent, readContent, deleteContent. The ReST framework (e.g., ReST store plugin 117, ReST store plugin 228) maps createContainer and uploadContent to the PUT method, readContent to the GET method and deleteContent to the DELETE method. In some embodiments, this mapping is hardcoded as part of the ReST framework. In other embodiments, the HTTP method to which a content management CRUD operation mapping is specified in the endpoint configuration. Here, endpoint configuration 300 includes configuration data 302 comprising headers to include with ReST requests to create containers in a GCP data store, configuration data 304 that comprises headers to include with ReST requests to upload content to a GCP data store, configuration data 306 that comprises headers to include with ReST requests to read content from a GCP data store, and configuration data 308 that comprises headers to include with ReST requests to delete content from a GCP data store. Further, endpoint configuration includes authentication configuration data 310 that points to a custom class (line 312). It can be noted that, here, the configuration data varies by operation type.

According to one embodiment, endpoint configuration 300 is stored as an XML file in an endpoint configuration directory with a filename, such as gcp-template.xml. The filename indicates that endpoint configuration 300 is the endpoint configuration for ReST-based data stores of the “gcp” type. Thus, for example, if the ReST framework (e.g., ReST store plugin 117 of FIG. 1 or ReST store plugin 228 of FIG. 2A and FIG. 2B) receives a request to perform createContainer, uploadContent, readContent, deleteContent operation with respect to a ReST-based store of type “gcp,” the ReST framework will load endpoint configuration 300 and create a ReST request using the endpoint URL from the ReST-based store details or object details, the HTTP method corresponding to the requested operation, the appropriate headers for the requested operation as specified in endpoint configuration 300 and any message body data provided with the request to perform the operation.

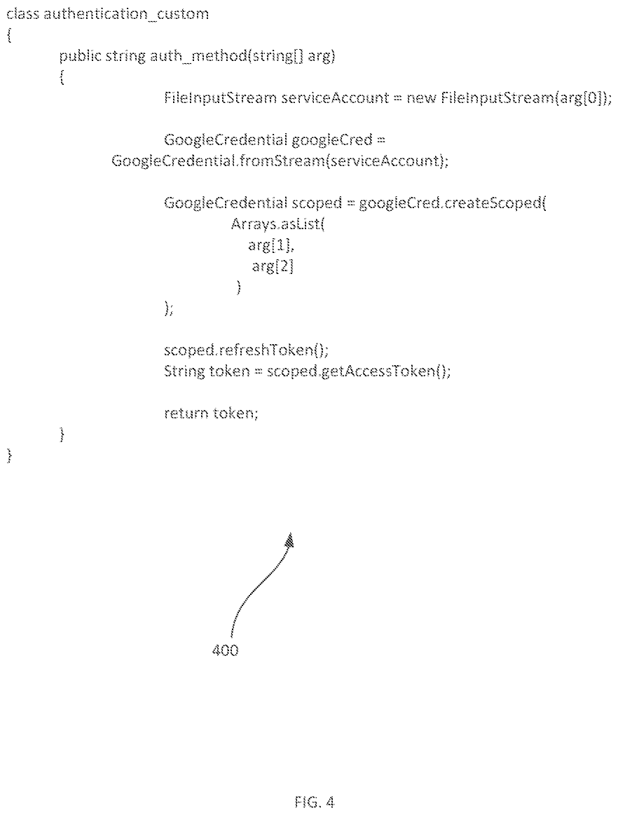

In the embodiment of FIG. 3, endpoint configuration 300 references a custom class (line 312) for generating a token to include in the authentication header of ReST requests for a “gcp” store. FIG. 4 illustrates one embodiment of a custom authentication class 400. The custom authentication class loads the service account from a JSON file, authenticates a credential with the service account, adds scopes to the credential, uses the scoped credentials to generate an access token, and returns the token to the ReST framework.

During runtime, the ReST framework (e.g., (e.g., ReST store plugin 117 of FIG. 1 or ReST store plugin 228 of FIG. 2A and FIG. 2B) will dynamically load the custom class using the three arguments specified in endpoint configuration 300 (i.e., the arguments specified for key=“0”, key=“1”, and key=“2”, which correspond to arg[0], arg[1], and arg[2] in custom authentication class 400. The custom class authenticates a Google credential with a service account, then generates an access token to be used in the authentication header of ReST requests.

FIG. 5 illustrates one embodiment of an endpoint configuration 500 for a Microsoft Azure data store, again including headers for createContainer, uploadContent, readContent, deleteContent.

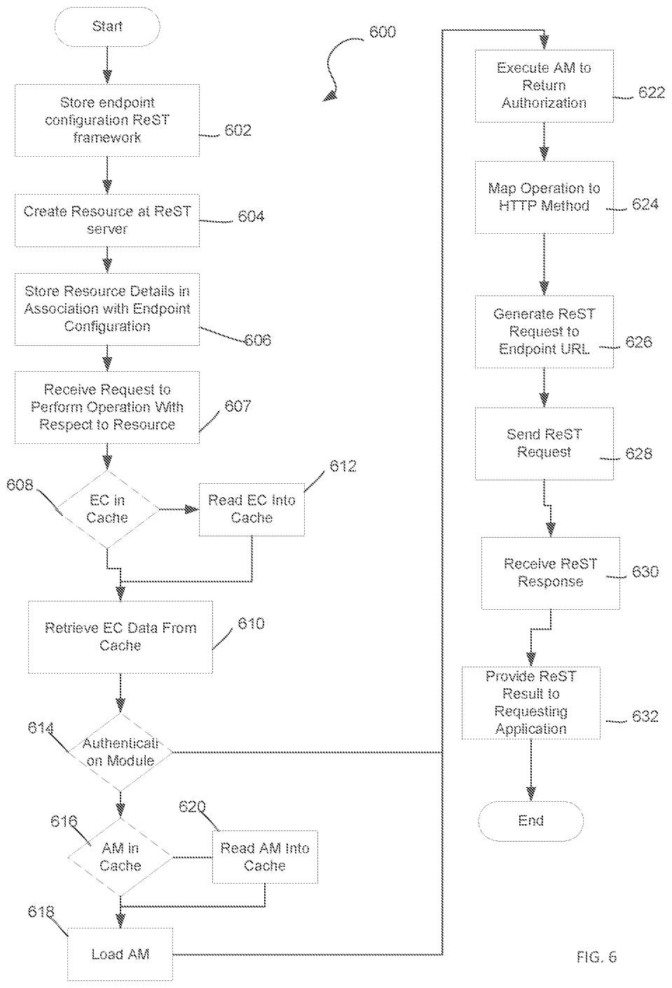

FIG. 6 is a flow chart illustrating one embodiment of a method 600 for a ReST framework for communicating with ReST interfaces. One or more steps of method 600 may be embodiment as computer-readable instructions stored on a non-transitory computer readable medium.

At step 602, an endpoint configuration for a ReST API is stored as configuration data for a ReST framework. For example, an endpoint configuration for a type of ReST-based store is stored as configuration data for the ReST framework. Furthermore, in some embodiments a custom authentication module is stored for use by the ReST framework.

The endpoint configuration specifies one or more of an endpoint, a header, a ReST method or an operation related parameter for use when generating ReST requests on resources or endpoints to which the endpoint configuration applies. An endpoint configuration, according to one embodiment, comprises endpoint configuration data that maps operations of an application—for example, operations of a first server—to one or more of an endpoint, an HTTP method, a header or a request parameter. In an even more particular embodiment, an endpoint configuration maps the operations of an application to headers, parameters, or HTTP methods based on tags in the endpoint configuration, the structure of the endpoint configuration data, or using other features of the endpoint configuration data. The endpoint configuration can have a format that can be parsed by the ReST framework to extract endpoint configuration data for various operations. In some embodiments, the endpoint configuration data varies for different operation types or resource types. Moreover, the available operations may vary by resource type, which can be indicated in the endpoint configuration data.

At step 604, a resource is created at a server that implements the ReST API. For example, a ReST-based data store is created. At step 606, the resource details for the resource are stored. The resource details may include, for example, a resource id, the endpoint URL of the resource, an authentication method or other details of the resource. In one embodiment, a rest_store object is created that includes a store id for the associated ReST-based store, an indication of a data store type, credentials for accessing the ReST-based store and the endpoint URL of the ReST-based store. In some embodiments, the rest_store object also specifies an authentication type. The resource details (for example the metadata of a rest_store object) associates the resource with the endpoint configuration stored at step 602.

It can be noted that step 602 and step 606 can be performed, in some embodiments, as the ReST framework or application utilizing the ReST framework (for example, server 112 in FIG. 1) is executing to dynamically update the available endpoint configurations and resources accessible via the ReST framework.

At step 607, the ReST framework receives a request from an application to perform an operation with respect to a resource—e.g., a request to create a new resource in a resource collection, read the resource, update the resource or delete the resource—and associated resource details. For example, ReST store plugin 117 may receive a request to create, update, read, or delete a container or file in a ReST-based store.

The associated resource details may be considered part of the request and can comprise a variety of information including, but not limited to, an endpoint URL and indication of an endpoint configuration to use. Other examples of resource details include, but are not limited to, an authentication type, credentials, and resource metadata or file data to include in a ReST request. Other examples of associated resource details include, but are not limited to, a store id of the ReST-based store, a store type of the ReST-based store, an endpoint URL for the ReST-based store or resource subordinate to the ReST-based store (e.g., a container URL or file URL), container metadata or file metadata, file content data, credentials for the target ReST-based store, or an authentication type.

At step 608, the ReST framework determines if the endpoint configuration associated with the request is in cache. If so, the ReST framework accesses the endpoint configuration from cache (step 610). For example, a ReST store plugin 117 accesses an endpoint configuration 132a, endpoint configuration 132b, or endpoint configuration 132c from cache 130, depending on the store type indicated by server 112 with a request. If not, the ReST framework reads the endpoint configuration into cache (step 612) and accesses the endpoint configuration from cache. For example, ReST store plugin 117 reads an endpoint configuration 126a, endpoint configuration 126b, or endpoint configuration 126c from endpoint configuration store 128 into cache 130, depending on the store type indicated by server 112 with a request.

The ReST framework parses the endpoint configuration accessed at step 608 to determine endpoints, headers, or request parameters specified for the associated operation or for all requests to endpoints to which the endpoint configuration applies.

At step 614, the ReST framework determines if an authentication module is to be executed based, for example, on an authentication type indicated in the resource details associated with the request or in the endpoint configuration. If an authentication module is to be executed, the ReST framework determines if the authentication module is in cache (step 616). If so, the ReST framework loads the authentication module from cache (step 618). For example, a ReST store plugin 117 accesses the authentication module from cache 138. If not, the ReST framework reads the authentication module into cache (step 620) and loads the authentication module from cache. For example, ReST store plugin 117 accesses an authentication module from authentication module store 136, reads the authentication module into cache 138 and accesses the authentication module from cache 138.

At step 622, the ReST framework executes the authentication module to return an authorization data (e.g., an authorization token) for inclusion in a ReST request (e.g., in an authentication header).

At step 624, the ReST framework maps the requested operation to an HTTP method.

At step 626, the ReST framework generates a ReST request that comprises an endpoint URL for the target resource, any headers or request parameters specified for the requested operation or for all requests to endpoints to which the endpoint configuration applies, the HTTP method, and any request data provided for inclusion in the ReST request. At step 628, the ReST framework sends the ReST request to the ReST server. For example, ReST store plugin 117 sends a ReST request to the ReST server 109a, ReST server 109b, or ReST server 109c, depending on the endpoint URL.

At step 630, the ReST framework receives a response to the ReST request. According to one embodiment, the ReST framework forwards the result of the ReST request to the requesting application (step 632).

FIG. 6 is merely an illustrative example, and the disclosed subject matter is not limited to the ordering or number of steps illustrated. Embodiments may implement additional steps or alternative steps, omit steps, or repeat steps.

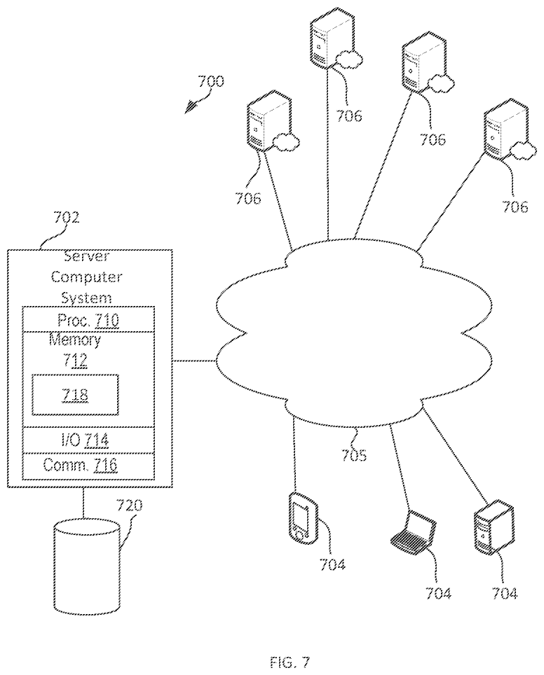

FIG. 7 depicts a diagrammatic representation of a distributed network computing environment where embodiments disclosed herein can be implemented. In the example illustrated, network computing environment 700 includes a server computer system 702 coupled to a plurality of client computers 704 and cloud computing systems 706 by a network 705.

A server computer system 702 comprises a computer processor 710 and associated memory 712. Computer processor 710 may be an integrated circuit for processing instructions, such as, but not limited to a central processing unit (CPU). Memory 712 may include volatile memory, non-volatile memory, semi-volatile memory or a combination thereof. Memory 712, for example, may include RAM, ROM, flash memory, a hard disk drive, a solid-state drive, an optical storage medium (e.g., CD-ROM), or other computer readable memory or combination thereof. Memory 712 implements a storage hierarchy that includes cache memory, primary memory and secondary memory. In some embodiments, memory 712 may include storage space on a data storage array. Server computer system 702 may also include input/output (“I/O”) devices 714, such as a keyboard, monitor, printer, electronic pointing device (e.g., mouse, trackball, stylus, etc.), or the like, and a communication interface 716, such as a network interface card, to interface with network 805.

According to one embodiment, server computer system 702 includes executable instructions 718 stored on a non-transitory computer readable medium coupled to computer processor 710. The computer executable instructions of server computer system 702 are executable to provide a ReST framework. Executable instructions 718 are further executable to provide a server, such as server 112, application server 204, method server 210 or other type of server that includes or utilizes a ReST framework. One or more components of server computer system 702 may use a database 720, which may be a portion of memory 712 or may be provided over a network by a database node. In some embodiments, database 720 comprises a metadata database, such as metadata database 114 or metadata database 208. For the purpose of illustration, a single system is shown for server computer system 702. However, server computer system 702 may comprise a plurality of computers (not shown) interconnected to each other over a network.

Cloud computing systems 706 include ReST servers that provide ReST-based stores as ReST resources. The ReST framework can be utilized to integrate the ReST-based stores as storage available for use by a server or other application of server computer system 702. Client computers can include client applications that act as clients with respect to the server of server computer system 702.

Portions of the methods described herein may be implemented in suitable software code that may reside within RAM, ROM, a hard drive or other non-transitory storage medium. Alternatively, the instructions may be stored as software code elements on a data storage array, magnetic tape, floppy diskette, optical storage device, or other appropriate data processing system readable medium or storage device.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random-access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A representational state transfer (ReST) framework method comprising:
storing endpoint configurations for heterogeneous ReST interfaces as configurable files consumable by a ReST framework;
receiving, by the ReST framework, a request to perform an operation and ReST resource details associated with the request to perform the operation, the ReST resource details comprising an endpoint URL for a target resource and an indication that a first endpoint configuration applies to servicing the request to perform the operation;
generating a ReST request, the ReST request including the endpoint URL for the target resource, a Hypertext Transfer Protocol (HTTP) method, and a header, wherein generating the ReST request comprises:
accessing the first endpoint configuration and extract first endpoint configuration data that is applicable to servicing the request to perform the operation, the first endpoint configuration data specifying the header; and
mapping the operation to the HTTP method; and
transmitting the ReST request to a ReST server.

2. The method of claim 1, wherein the request is received from a server of a content management system.

3. The method of claim 1, further comprising:
storing an object representing a ReST-based store, the object representing the ReST-based store comprising a data store type and an endpoint URL for the ReST-based store, wherein the first endpoint configuration is stored in association with the data store type.

4. The method of claim 3, wherein the target resource is the ReST-based store and the endpoint URL for the target resource is the endpoint URL for the ReST-based store.

5. The method of claim 3, further comprising a container object representing a container in the ReST-based store, the container object comprising an endpoint URL for the container and a storage location indicating that the container is in the ReST-based store.

6. The method of claim 5, wherein the target resource is the container in the ReST-based store and wherein the method further comprises:
accessing the container object to retrieve details of the container including the storage location and the endpoint URL for the container;
based on the storage location from the container object, accessing the object representing the ReST-based store to retrieve the data store type;
including the data store type in the ReST resource details associated with the request as the indication that the first endpoint configuration applies.

7. The method of claim 3, further comprising storing a content object representing a file stored in the ReST-based store, the content object comprising an endpoint URL for the file and a storage location indicating that the file is stored in the ReST-based store.

8. The method of claim 7, wherein the target resource is the file stored in the ReST-based store and wherein the method further comprises:
accessing the content object to retrieve details of the file including the storage location and the endpoint URL for the file;
based on the storage location from the content object, accessing the object representing the ReST-based store to retrieve the data store type; and
including the data store type in the ReST resource details associated with the request as the indication that the first endpoint configuration applies.

9. The method of claim 1, further comprising:
determining that the first endpoint configuration is not cached; and
based on the determination that the first endpoint configuration is not cached, reading the first endpoint configuration from a first location into a cache, wherein the first endpoint configuration is accessed from the cache.

10. The method of claim 1, further comprising:
storing an authentication module that is dynamically executable by the ReST framework, wherein generating the ReST request comprises:
determining that the first endpoint configuration references the authentication module; and
based on the determination that the first endpoint configuration references the authentication module, executing the authentication module to return authentication information, wherein the ReST request includes the authentication information.

11. The method of claim 10, further comprising:
after determining that the first endpoint configuration references the authentication module and prior to executing the authentication module, determining that the authentication module is not cached; and
based on the determination that the authentication module is not cached, reading the authentication module from a first location into a cache.

12. A non-transitory, computer-readable medium having stored therein instructions executable by a computer for:
accessing configurable files storing endpoint configurations for heterogeneous representational state transfer (ReST) interfaces;
receiving a request to perform an operation and ReST resource details associated with the request to perform the operation, the ReST resource details comprising an endpoint URL for a target resource and an indication that a first endpoint configuration applies to servicing the request to perform the operation;
generating a ReST request, the ReST request including the endpoint URL for the target resource, a Hypertext Transfer Protocol (HTTP) method, and a header, wherein generating the ReST request comprises:
accessing the first endpoint configuration and extract first endpoint configuration data that is applicable to servicing the request to perform the operation, the first endpoint configuration data specifying the header; and
mapping the operation to the HTTP method; and
transmitting the ReST request to a ReST server.

13. The non-transitory, computer-readable medium of claim 12, wherein the request is received from a server of a content management system.

14. The non-transitory, computer-readable medium of claim 12, further comprising instructions executable by the computer for storing an object representing a ReST-based store, the object representing the ReST-based store comprising a data store type and an endpoint URL for the ReST-based store, wherein the first endpoint configuration is stored in association with the data store type.

15. The non-transitory, computer-readable medium of claim 14, wherein the target resource is the ReST-based store and the endpoint URL for the target resource is the endpoint URL for the ReST-based store.

16. The non-transitory, computer-readable medium of claim 14, further comprising instructions executable by the computer for storing a container object representing a container in the ReST-based store, the container object comprising an endpoint URL for the container and a storage location indicating that the container is in the ReST-based store.

17. The non-transitory, computer-readable medium of claim 16, further comprising instructions executable by the computer for:
accessing the container object to retrieve details of the container including the storage location and the endpoint URL for the container;
based on the storage location from the container object, accessing the object representing the ReST-based store to retrieve the data store type; and
including the data store type in the ReST resource details associated with the request as the indication that the first endpoint configuration applies, wherein the container is the target resource.

18. The non-transitory, computer-readable medium of claim 14, further comprising instructions executable by the computer for storing a content object representing a file stored in the ReST-based store, the content object comprising an endpoint URL for the file and a storage location indicating that the file is stored in the ReST-based store.

19. The non-transitory, computer-readable medium of claim 18, further comprising instructions executable by the computer for:
accessing the content object to retrieve details of the file including the storage location and the endpoint URL for the file;
based on the storage location from the content object, accessing the object representing the ReST-based store to retrieve the data store type; and
including the data store type in the ReST resource details associated with the request as the indication that the first endpoint configuration applies, wherein the file is the target resource.

20. The non-transitory, computer-readable medium of claim 12, further comprising instructions executable by the computer for:
determining that the first endpoint configuration is not cached; and
based on the determination that the first endpoint configuration is not cached, reading the first endpoint configuration from a first location into a cache, wherein the first endpoint configuration is accessed from the cache.

21. The non-transitory, computer-readable medium of claim 12, further comprising instructions executable by the computer for:
storing an authentication module, wherein generating the ReST request comprises:
determining that the first endpoint configuration references the authentication module; and
based on the determination that the first endpoint configuration references the authentication module, dynamically executing the authentication module to return authentication information, wherein the ReST request includes the authentication information.

22. The non-transitory, computer-readable medium of claim 21, further comprising instructions executable by the computer for:
after determining that the first endpoint configuration references the authentication module and prior to executing the authentication module, determining that the authentication module is not cached; and
based on the determination that the authentication module is not cached, reading the authentication module from a first location into a cache.
